(19) United States
(12) Patent Application Publication
(10) Pub. No.: US 2013/0159277 A1
(43) Pub. Date: Jun. 20, 2013

(54) TARGET BASED INDEXING OF MICRO-BLOG CONTENT

(71) Applicants: Xiaohua Liu, Beijing (CN); Ming Zhou, Beijing (CN); Furu Wei, Bejing (CN)

(72) Inventors: Xiaohua Liu, Beijing (CN); Ming Zhou, Beijing (CN); Furu Wei, Bejing (CN)

(73) Assignee: Microsoft Corporation, Redmond, WA (US)

(21) Appl. No.: 13/326,028

(22) Filed: Dec. 14, 2011

(51) Int. Cl. G06F 17/30

(52) U.S. Cl. 707/709; 707/740; 707/E17.108; 707/E17.089

(57) ABSTRACT

Target based indexing of micro-blog content may include extracting, labeling, and indexing data contained in micro-blog entries. For example, by adapting natural language processing (NLP) technologies to a micro-blog entry, data is extracted in order to create an index. In one embodiment, a search engine may access the index in order to return results of a search query. In another embodiment, a user interface may display micro-blog entries categorically, allowing the user to access micro-blog entries by event, quote, opinion, or other category.

### BACKGROUND

An increase in micro-blogging popularity has led to a vast quantity of available micro-blog content. Indexing this micro-blog content is advantageous for several reasons. For instance, an index may be accessed to produce meaningful search results. Indexing a micro-blog entry requires data extraction techniques that capture the entry's subject matter and intended meaning. However, micro-blog entries are inherently unstructured and often contain informal language, making it difficult for existing data extraction techniques to effectively interpret the meaning of each entry. For this reason, a search query dependent on existing data extraction techniques may return results from an index that has limited informational value. For example, one data extraction technique may misconstrue the meaning of a word or infer the context of a phrase incorrectly. Other data extraction techniques may only focus on finding a single keyword within the entry, and thereby produce an index with limited or inaccurate classification.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

This disclosure describes example processes for extracting data from a micro-blog entry. In addition, this disclosure also describes example processes for labeling and indexing the extracted data and the micro-blog entry. By adapting natural language processing technologies to a micro-blog entry, the micro-blog entry is categorized, labeled, and/or indexed. In one embodiment, an index containing the extracted data and processed micro-blog entries is accessed to return results of a search query. In another embodiment, a user interface may display micro-blog entries categorically.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 is a schematic diagram of an example architecture for target based indexing of a micro-blog entry.

FIG. 2 illustrates several example modules that may reside on a processing server responsible for creating a target based micro-blog index.

FIG. 3 is a schematic diagram, which illustrates extracting data from a micro-blog entry, and making available to a web browser both the extracted data and the micro-blog entry.

FIG. 4 is a screen rendering of an example user interface (UI) that includes data from a target based micro-blog index. As illustrated, data is presented according to an opinion, event, and quote.

FIG. 5 is a screen rendering of an example UI that illustrates search results by opinion, event, and quote in greater detail.

FIG. 6 is a flow diagram showing an illustrative process of extracting and indexing data from micro-blog entries.

FIG. 7 is a flow diagram showing an illustrative process of a search in conjunction with target based indexing.

### DETAILED DESCRIPTION

### Overview

As discussed above, the effectiveness of existing technologies to extract data from a micro-blog varies. Each approach attempts to extract the most useful content from the micro-blog entry for improved indexing and potentially, more meaningful search results. However, acquiring useful content from micro-blogs is challenging, due in part to the quantity of available micro-blog entries as well as their short, repetitive, and unstructured nature. For example, one conventional approach applies technologies designed for extracting information from a web page to micro-blogs. However, the informal and unstructured nature of micro-blogs is less suited for this approach. Some conventional technologies extract only a key-word from which it labels the micro-blog entry. This leads to an index that produces search results of limited meaning. In short, using available data extraction processing on micro-blogs produces limited effectiveness with regard to labeling, indexing, and searching.

This disclosure describes example processes for extracting meaningful data from a micro-blog entry. This disclosure further describes labeling and indexing the extracted data to support a user submitted search query. Data extraction from micro-blog entries maybe achieved by implementing a series of processing including, but not limited to, natural language processing (NLP) technologies. By virtue of having NLP technologies adapted for micro-blog entries, useful data is extracted and subsequently indexed. The extracted data stored in an index may include, for example, a word, a phrase, metadata, named entities, an event and/or an opinion associated with the micro-blog entry. In one implementation, the extracted data along with the micro-blog entry are available to produce search results in response to a search query. In another implementation, the search results, e.g., the micro-blog entry and associated data may be displayed by a category in a user interface (UI). The displayed categories in the UI may include, for example, an event, a name, or an opinion. Alternatively, another implementation may include displaying micro-blog entries in a categorized (e.g. hierarchical) fashion for browsing. For example, a browser or application may display categorized micro-blog entries without receiving a web search.

In some instances, extracting data from micro-blog entries according to this disclosure begins with pre-processing. Pre-processing may include of normalization, parsing, and/or removing micro-blog entries based on a number of terms in an entry. According to a specific example, a processing server implements normalization to identify and correct words that are misspelled or adhere to an informal nature. For example, as a result of normalization, “looooove” is converted to “love.” Next, parsing determines a grammatical structure of the micro-blog by using, for example, part-of-speech (POS), chunking, and dependency parsing. Pre-processing concludes by removing micro-blog entries from further processing. Removing micro-blog entries may be based on a number of terms in an entry. For instance, if the micro-blog entry has three or fewer words, it may be removed from any further processing. Additionally or alternatively, removing micro-blog entries during pre-processing may be based on duplicate content, profanity, or spam contained in the micro-blog entry.

The pre-processing steps of normalization, parsing, and removing micro-blog entries may be followed by implementing one or more NLP technologies. The one or more NLP technologies may include named entity recognition (NER), semantic role labeling (SRL), and sentiment analysis (SA). Again, one, two, or possibly all three of these technologies may be applied to the micro-blog entry. Notably, each of the one or more natural language processing technologies described herein is adapted for application to micro-blog entries. Nonetheless, the techniques described herein are not limited to micro-blog entries. For instance, the techniques described herein may also apply to blog entries, e-mail entries, or other web page entries.

Returning to the processing of the micro-blog entry, NER may be applied to the entry to locate and classify elements into predefined categories. In other words, NER may identify text elements from a passage and classify the identified text elements into predefined categories. For instance, pre-defined categories may include names of persons, organizations, locations, events, opinions, expressions of times, quantities, monetary values, percentages, etc. As an example, in “Obama speaks Wednesday,” NER would identify and assign ‘Obama’ to the person category and ‘Wednesday’ to the category associated with expressions of time.

Another NLP technology may include SRL. According to this disclosure, SRL, identifies each predicate, and further identifies the argument associated with the predicate and thereafter performs word level labeling of the micro-blog content. For instance, SRL may identify a role or relationship that a word has in relation to other words, thereby providing a framework in which to label the word.

Another example of a NLP technology that may be implemented according to this disclosure includes SA. Sentiment analysis aims to determine an attitude of a writer or a speaker with respect to a topic or overall message in a text entry. In one implementation, SA may be applied to both a search query and a micro-blog entry. For instance, SA may determine an opinion of a search query and classify an opinion of the micro-blog entry based on its relation to the opinion in the search query.

After the pre-processing and implementation of the one or more NLP technologies, the micro-blog entry may be categorized and indexed. The index stores both the extracted data and the micro-blog entry. In some implementations, search results are returned from the index and displayed categorically. Additionally or alternatively, the opinions of each micro-blog entry, as it pertains to the search query, may be displayed in a user interface.

The techniques described herein may apply to micro-blog entries available from any content provider. For ease of illustration, many of these techniques are described in the context of micro-blog entries associated with micro-blog sites, such as Twitter®, Tumblr®, Plurk®, Jaiku®, and Flipter®. However, the techniques described herein are not limited to micro-blog sites. For example, the techniques described herein may be used to extract and index data associated with user generated content with social networking sites, blogging sites, bulletin board sites, customer review sites, and the like.

### Illustrative Architecture

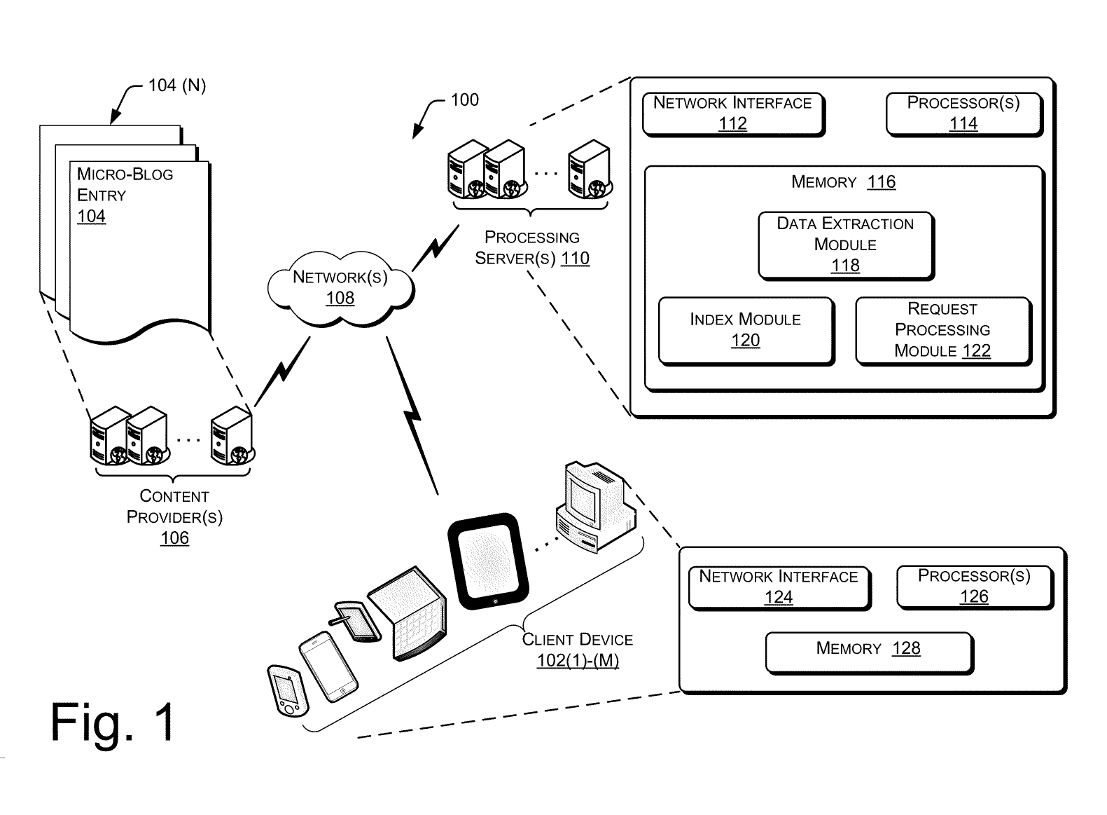

FIG. 1 is a schematic diagram of an example architecture for enabling target based indexing and searching an index of micro-blog entries. The target based indexing system 100 includes a client device 102(1), . . . , 102(M) (collectively 102), a micro-blog entry 104(1), . . . , 104(N) (collectively 104), a content provider 106, a network 108, and a processing server 110. Processing server 110 may receive over network 108 the micro-blog entry 104 via the content provider 106. The processing server 110 then extracts data from the micro-blog entry 104 and stores in an index both the extracted data and the micro-blog entry. In one embodiment, the client device 102 may be used to generate a search query, send the query to the processing server 110 to carry out the search, and processing server 110 provides search results to the client device 102.

Within the architecture 100, the client device 102 may access one or more processing servers 110 via the network 108. As illustrated, the client device 102 may include a personal computer, a tablet computer, a laptop computer, a personal digital assistant (PDA), or a mobile phone. In addition, the client device 102 may be implemented as any number of other types of computing devices including, for example, PCs, set-top boxes, game consoles, electronic book readers, notebooks, and the like. The network 108, meanwhile, represents any one or combination of multiple different types of wired and/or wireless networks, such as cable networks, the Internet, private intranets, and so forth. Again, while FIG. 1 illustrates the client device 102 communicating with the processing server 110 over the network 108, the techniques may apply in any other networked or non-networked architectures.

The micro-blog 104 may include any user-generated content available from the content provider 106. Alternatively, the content provider 106 may access the micro-blog from a separate local and/or remote database (not shown), or the like.

The content provider 106 may provide one or more micro-blog entries 104 to the processing server 110 over network 108. In some instances, the content provider 106 comprises a site (e.g., a website) that is capable of handling requests from the processing server 110 and serving, in response, various micro-blog entries 104. For instance, the site can be any type of site that contains micro-blog entries including, informational sites, social networking sites, blog sites, search engine sites, news and entertainment sites, and so forth. In another example, the content provider 106 provides micro-blog entries 104 for the processing server 110 to download, store, and process locally. The content provider 106 may additionally or alternatively interact with the processing server 110 or provide content to the processing server 110 in any other way.

The network 108, meanwhile, represents any one or combination of multiple different types of wired and/or wireless networks, such as cable networks, the Internet, private intranets, and the like.

The upper-right portion of FIG. 1 illustrates information associated with the processing server 110 in greater detail. As illustrated, the processing server 110 contains a network interface 112, one or more processors 114, and memory 116, memory 116 stores a data extraction module 118, an index module 120, and a request processing module 122. The one or more processors 114 and the memory 116 enable the processing server 110 to perform the functionality described herein. The network interface 112 enables the processing server 110 to communicate with other components over the network 108. For example, the network interface 112 may receive a search query request from the client device 102 or alternatively, receive the micro-blog entry 104 from the content provider 106.

The data extraction module 118 receives and performs a series of processes in order to pre-process, extract data, and label the micro-blog entries 104. By way of example and not limitation, the data extraction module 118 extracts data pertaining to relevant topics, events, quotes, and opinions inherent in the micro-blog entry 104.

The index module 120 stores the micro-blog entry 104 along with extracted data resultant from the series of processes performed by the data extraction module 118. However, if the micro-blog entry 104 is determined by the data extraction module 118 to be noisy (e.g., hard to read or uninformative) then the micro-blog entry 104 may be excluded by the index module 120. For instance, a noisy micro-blog entry may be short (e.g., less than three words), contain meaningless words or self-promotion (e.g., babble, spam, or the like), or lack structure due to an informal style. Excluded entries may not be indexed and stored.

The request processing module 122 enables the processing server 110 to receive and/or send a request. For example, the request processing module 122 may request the micro-blog entry 104 from the content provider 106. For instance, the request processing module 122 may repeatedly download micro-blog entries from the content provider 106. The request to the content provider 106 may be in the form of an application program interface (API) call. Alternatively, the request processing module 122 may receive a request from a search box in a web browser of the client device 102. In another implementation, the request processing module 122 may receive a request from a search engine of the client device 102. Here, the request may include, for example, a semantic search query, or alternatively, a structured search query. Alternatively, the request processing module 122 may be omitted

In the illustrated implementation, the processing server 110 is shown to include multiple modules and components. The illustrated modules may be stored in memory 116 (e.g., volatile and/or nonvolatile memory, removable and/or non-removable media, and the like), which may be implemented in any method or technology for storage of information, such as computer-readable instructions, data structures, program modules, or other data. Such memory includes, but is not limited to, random access memory (RAM), read only memory (ROM), electrically erasable programmable ROM (EEPROM), flash memory or other memory technology, compact disk ROM (CD-ROM), digital versatile disks (DVD) or other optical storage, magnetic cassettes, magnetic tape, magnetic disk storage or other magnetic storage devices, redundant array of independent disks (RAID) storage systems, or any other medium which can be used to store the desired information and which can be accessed by a computing device. While FIG. 1 illustrates the processing server 110 as containing the illustrated modules, these modules and their corresponding functionality may be spread amongst multiple other actors, each of whom may or may not be related to the processing server 110.

In the illustrated example, the client device 102 comprises a network interface 124, one or more processors 126, and memory 128. The network interface 124 allows the client device 102 to communicate with the processing server 110. The one or more processors 126 and the memory 128 enable the client device 102 to perform the functionality described herein. Here, the client device 102 may request, via a browser or application, one or more micro-blog entries 104 from the processing server 110 and/or the content provider 106.

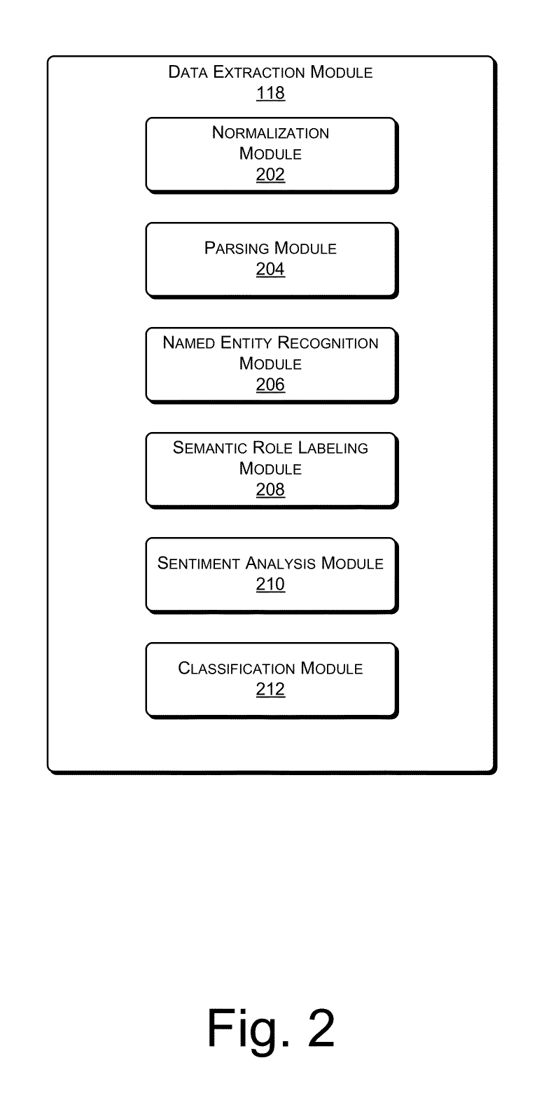

FIG. 2 illustrates several example modules that may reside in the data extraction module 118 of the processing server 110 of FIG. 1. For instance, the data extraction module 118 may include a normalization module 202, a parsing module 204, a named entity recognition (NER) module 206, a semantic role labeling module (SRL) 208, a semantic analysis (SA) module 210, and a classification module 212.

The normalization module 202 may correct words that contain missing characters, characters in the wrong order, abbreviations, or character repetition. For example, given a micro-blog entry that recites “thriler by Micheal Jackson is so gr8! Looooove ittt!<3”, the normalization module 202 identifies “thriler” as missing a character, and corrects the word to “thriller.” In addition, “Micheal” is identified as containing characters in the wrong order and is corrected to “Michael” by the normalization module 202. Also from the example above, the abbreviations “gr8” and “<3” are corrected to “great” and “love”, respectively. Lastly, words with character repetition, such as “Looooov” and “ittt” are identified and corrected to “Love” and “it”. The normalization module 202 may achieve the above corrections by, for example, implementing a source channel-model. In one specific example, the source channel-model may include equation:

$${arg max}_{s} p ( s ) p ( t \vert s ) = {arg max}_{s} p ( s ) {\prod }_{i} p ( {t}_{i} \vert {s}_{i} ) \qquad ( 1 )$$

In the preceding equation, t is the observed micro-blog entry, s is the correct micro-blog entry, and tᵢ and sᵢ are words in t and s, respectively. p(s) may be estimated by a trigram language model trained on micro-blog entries, for example. If tᵢ is an in-vocabulary (IV) word or contains capitalized letters, sᵢ is set as tᵢ. Otherwise, generating sᵢ takes place as follows:

for a missing character, check the edit distance with the IV words;

for characters in wrong order, swap two adjacent letters and check a dictionary;

for abbreviations, check a manual table; and

for character repetition, replace any three or more continuous letters with one or two letters.

The parsing module 204 determines grammar and parts of speech (POS) of the micro-blog entry 104. In one example, this may be achieved by POS tagging performed by a tagging algorithm such as an OpenNLP POS tagger (see http://opennlp.sourceforge.net/projects.html). In another implementation, word stemming may be performed by using a word stem mapping table. That is, word stemming reduces words to their stem, base, or root form and maps related stems together. In yet another implementation, syntactic parsing may be, for instance, facilitated by a Maximum Spanning Tree dependency parser, such as that described by McDonald et al., Non-projective Dependency Parsing using Spanning Tree Algorithms, Proceedings of Human Language Technology Conference and Conference on Empirical Methods in Natural Language Processing (HLT/EMNLP), pages 523-530, Vancouver, October 2005. Additionally or alternatively, chunking (e.g., shallow parsing which identifies noun groups, verbs, verb groups, etc.) and/or dependency parsing (e.g., determining phrase structure by a relation between a word and its dependents) may be implemented.

The NER module 206 locates and classifies elements of the micro-blog entry 104 into predefined categories. By way of example and not limitation, this may be achieved by combining a K-Nearest Neighbors (KNN) classifier with a linear Conditional Random Fields (CRF) model under a semi-supervised learning framework. The KNN based classifier conducts pre-labeling to collect global coarse data across multiple micro-blog entries. In one specific example, a KNN training process may be implemented by the following algorithm:

| Require: Training tweets ts. | |
|---|---|
| 1: | Initialize the classifier lk:lk = Ø. |
| 2: | for Each tweet t ε ts do |
| 3: | for Each word,label pair (w, c) ε t do |
| 4: | Get the feature vector \vec{w}: \vec{w} = |
| | reprw(w, t). |
| 5: | Add the \vec{w} and c pair to the classifier: lk = |
| | lk ∪ {( \vec{w}, c)}. |
| 6: | end for |
| 7: | end for |
| 8: | return KNN classifier lk. |

In one specific example, KNN Prediction may be implemented by the following algorithm:

| Require: KNN classifier lₖ; word vector \vec{w} | |
|---|---|
| 1: | Initialize nb, the neighbors of \vec{w}: nb = neighbors(lₖ, \vec{w}). |
| 2: | Calculate the predicted class c*: c* = argmax_{c} Σ₍\vec{_{w}}_{,c′)∈nb} δ(c, c′). |
| cos (w, w′). | |
| 3: | Calculate the labeling confidence cf: |
| $cf = \frac{{\sum }_{( \vec{w} , {c}^{′} ) ∈ nb} δ ( c , {c}^{′} ) \cdot cos ( \vec{w} , {\vec{w}}^{′} )}{{\sum }_{( \vec{w} , {c}^{′} ) ∈ nb} cos ( \vec{w} , {\vec{w}}^{′} )}$ | |
| 4: | return The predicted label c* and its confidence cf. |

Meanwhile, the CRF model conducts sequential labeling to capture fine-grained information encoded in the micro-blog entry 104. Semi-supervised learning makes use of both labeled and unlabeled data for training the NER module 206. Examples of semi-supervised learning methods may include a variety of bootstrapping algorithms, using word clusters learned from unlabeled text, or a bag-of-words model. Initially, a lack of training data may be augmented by using gazetteers that represent general knowledge across a multitude of domains.

The SRL module 208 identifies each predicate, and further identifies an argument associated with the predicate. Thereafter, the SRL module 208 conducts word level labeling. This may be accomplished, for instance, by way of a CRF model. Specifically, SRL may be applied to a micro-blog, for example, by the following algorithm:

| Require: Micro-blog stream i;clusters cl;output stream o. | |
|---|---|
| 1: | Initialize l, the CRF labeler: l = train(cl). |
| 2: | while Pop a tweet t from i and t ≠ null do |
| 3: | Put t to a cluster c: c = cluster(cl, t). |
| 4: | Label t with l:(t, {(p, s, cf)}) = label(l, c, t). |
| 5: | Update cluster c with labeled results (t, {(p, s, cf)}). |
| 6: | Output labeled results (t, {(p, s, cf)}) to o. |
| 7: | end while |
| 8: | return o. |

In the preceding algorithm, train denotes a machine learning process to get a labeler l. The cluster function puts the new micro-blog entry into a cluster; the label function generates predicate-argument structures for the input micro-blog entry with the help of the trained model and the cluster; p, s, and cf denotes predicate, a set of argument and role pairs related to the predicate and the predicated confidence, respectively. To prepare the initial clusters required by the SRL module 208 as its input, a predicate-argument mapping method may be used to obtain some automatically labeled micro-blog entries. These automatically labeled micro-blog entries are then organized into groups using a bottom-up clustering procedure.

Self-training the SRL module 208 initially requires a small amount of manually labeled data as seeds to train the labeler. To accomplish this task, micro-blog entries are selected based on an agreement of two Conditional Random Fields (CRF) based labelers, which are trained on the randomly evenly split labeled data (e.g., labeled data that is randomly split in two parts in which each part has the same number of labels). If both labelers output the same label, the micro-blog entry 104 may be regarded as correctly labeled. In addition to using two labelers, a selection of a new micro-blog entry is further based on its content similarity to previously selected micro-blogs. As an example, the selection of a training micro-blog entry may be implemented by the following algorithm:

| Require: Training micro-blogs ts; micro-blog t; labeled results by | |
|---|---|
| l{(p, s, cf)}; labeled results by l′ {(p, s, cf)}′. | |
| 1: | if {(p, s, cf) ≠ {(p, s, cf)}′ then |
| 2: | return FALSE. |
| 3: | end if |
| 4: | if ∃cf ε {(p, s, cf)} ∪ {(p, s, cf)} < α then |
| 5: | return FALSE. |
| 6: | end if |
| 7: | if ∃ t′ ε ts sim (t, t′) > β then |
| 8: | return FALSE. |
| 9: | end if |
| 10: | return TRUE. |

In the preceding algorithm, p, s, and cf denote predicate, a set of argument and role pairs related to the predicate, and the predicated confidence, respectively. Two independent linear CRF models are denoted as l and l′. In other implementations, the number of labelers used to label the micro-blog entry 104 may vary. For instance, label output from a single labeler may be used. Alternatively, the output from more than two labelers may be compared when determining accuracy of a label associated with the micro-blog entry 104.

In one specific example, self-training of SRL may be accomplished with the following algorithm:

Require: Tweet stream i; training tweets ts; output stream o.

| | |
|---|---|
| 1: | Initialize two CRF based labelers l and l′: (l, l′) = train (cl). |
| 2: | Initialize the number of new accumulated tweets from training n: n = 0. |
| 3: | while Pop a tweet t from i and t ≠ null do |
| 4: | Label t with l:(t, {(p, s, cf)}) = label(l, c, t). |
| 5: | Label t with l′:(t, {(p, s, cf)}′) = label(l′, c, t). |
| 6: | Output labeled results (t, {(p, s, cf)}) to o. |
| 7: | if select(t, {(p, s, cf)}, {(p, s, cf)}′) then |
| 8: | Add t to training set ts:ts = ts ∪ {t, {(p, s, cf)}}; n = n +1. |
| 9: | end if |
| 10: | if n > N then |
| 11: | Retrain labelers: (l, l′) = train(cl); n = 0. |
| 12: | end if |
| 13: | if \|ts\|>M then |
| 14: | shrink the training set: ts = shrink(ts). |
| 15: | end if |
| 16: | end while |

In the preceding algorithm, train denotes a machine learning process to get two independent statistical models l and l′, both of which use linear CRF models; the label function generates predicate-argument structures with the help of the trained mode; p, s and cf denote a predicate, a set of argument and role pairs related to the predicate and the predicted confidence, respectively; the select function tests if a labeled tweet meets the selection criteria; N and M are the maximum allowable number of new labeled training tweets and training data, respectively; the shrink function keeps removing the oldest tweets from the training data set, until its size is less than M.

The SA module 210 determines an opinion of a search query and classifies an opinion of the micro-blog entry based on its relation to the opinion in the search query. This may be accomplished, for instance, based on subjectivity classification, polarity classification, and graph-based optimization. For example, the micro-blog entry 104 may be labeled as positive, negative, or natural. Subjectivity classification may, for example, incorporate a binary SVM classifier to determine if the micro-blog is subjective or neutral about a target of an entry. Instead of only focusing on the target of the sentiment, subjectivity classification may take into account other nouns in the entry. If the micro-blog is classified as subjective, polarity classification, which also incorporates a binary SVM classifier, determines if the micro-blog is positive or negative about the target. Training of the classifiers may be accomplished by using SVM-Light with a linear kernel (see http://svmlight.joachims.org/). Finally, graph-based optimization takes into account related micro-blogs entries to improve the accuracy of the determined sentiment. For example, micro-blog entries may be considered related if they contain the same subject, the same author, or contain a reply. In one specific implementation, the probability of a micro-blog belonging to a specific class may, for example, be based on the following equation:

$$p ( c \vert t , G ) = p ( c \vert t ) {\sum }_{N ( d )} p ( c \vert N ( d ) ) p ( N ( d ) ) \qquad ( 2 )$$

In the preceding equation, c is the sentiment label of a micro-blog entry which belongs to {positive, negative, neutral}, G is the micro-blog entry graph, N(d) is a specific assignment of sentiment labels to all immediate neighbors of the micro-blog entry 104, and t is the content of the micro-blog entry 104. Output scores of the micro-blog entry 104 by the subjectivity and polarity classifiers are converted into probabilistic form and used to approximate p (c|t). Then a relaxation labeling algorithm may be used on the graph to iteratively estimate p (c|t,G) for all micro-blog entries. After the iteration ends, for any micro-blog entry in the graph, the sentiment label that has the maximum p (c|t,G) is considered the final label.

The classification module 212 classifies the micro-blog entry 104 into pre-defined categories. For example, classifying the micro-blog entry 104 into categories may be accomplished by implementing a KNN classifier. Examples of pre-defined categories may include names of persons, organizations, locations, events, opinions, expressions of times, quantities, monetary values, percentages, etc. In another implementation, the classification module 212 may identify and subsequently drop noisy, e.g., redundant or uninformative, micro-blog entries.

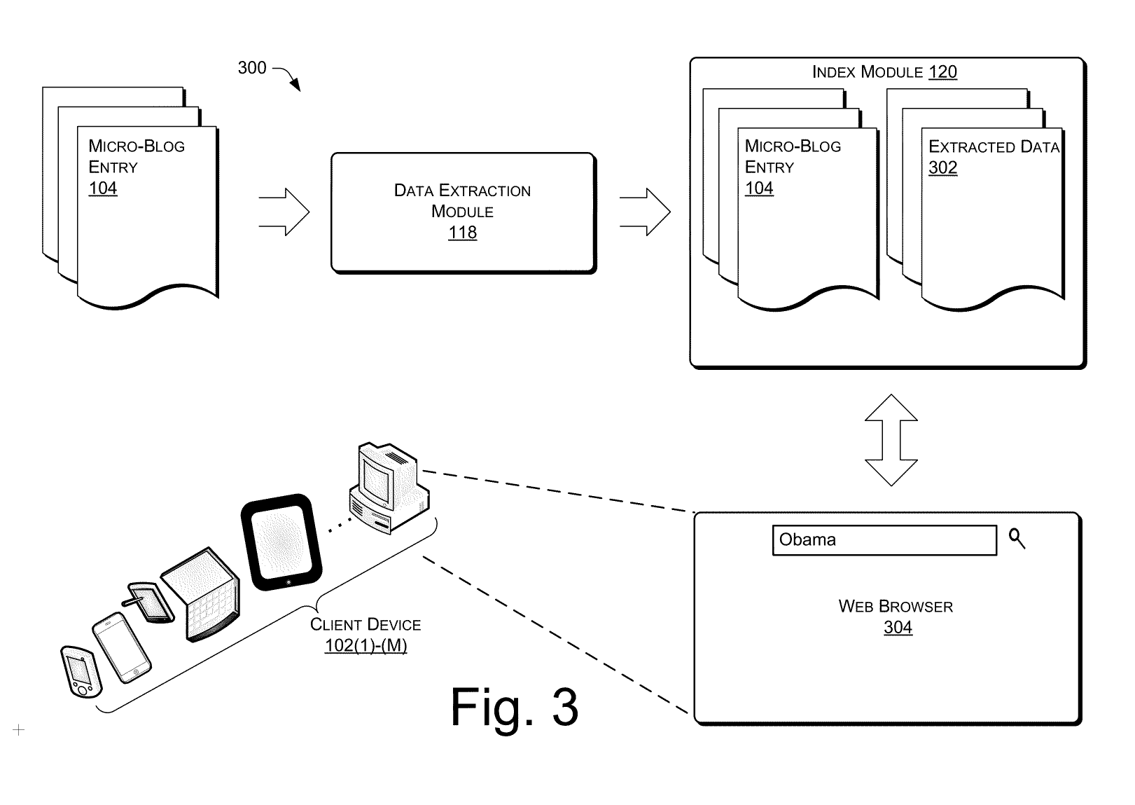

FIG. 3 is a schematic diagram, which illustrates a framework 300 for extracting data from a micro-blog entry, and providing the extracted data and the micro-blog entry to a web browser or other application of a client device 102. In the illustrated example, the data extraction module 118 processes the micro-blog entry 104 and generates extracted data 302. The extracted data 302 may include, for example, various entries including words, phrases, metadata, named entities, events, and opinions. The index module 120 stores the micro-blog entry and the extracted data 302. In one implementation, the index module 120 receives a request from a web browser 304. In response to receiving the request, the index module 120 returns the micro-blog entry 104 and the extracted data 302 that satisfies the request.

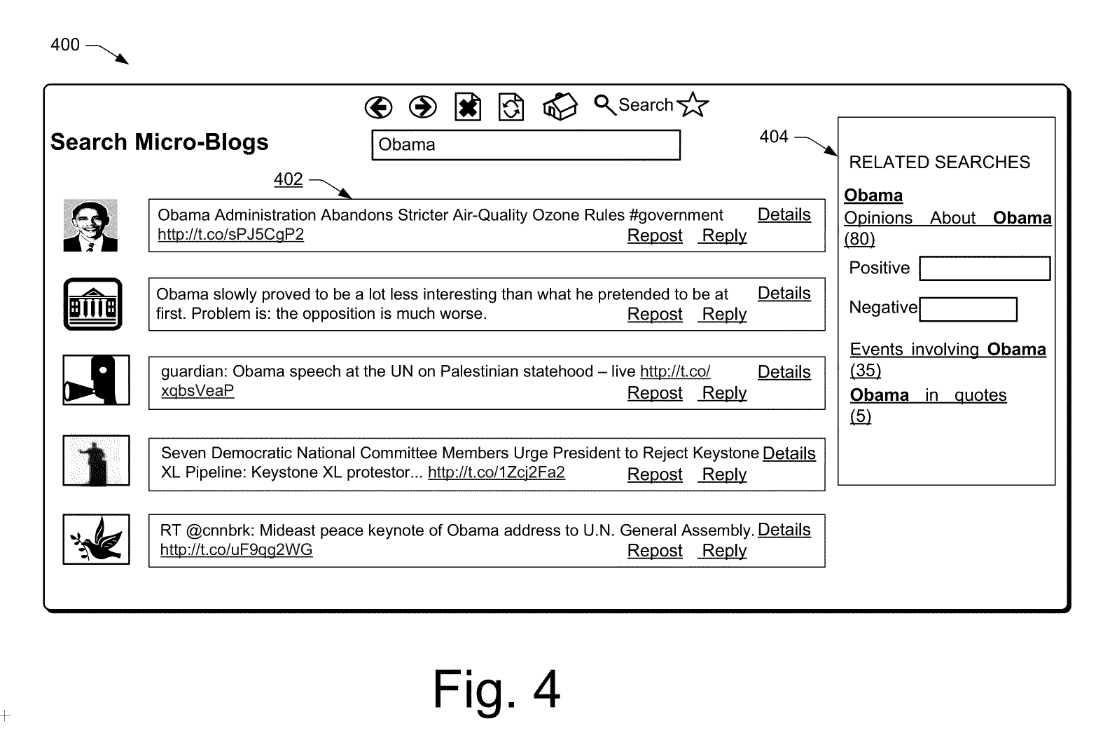

FIG. 4 is a screen rendering of an example user interface (UI) 400 that includes a plurality of micro-blog entries 402. In some instances, the UI 400 may receive the plurality of micro-blog entries 402 from the index module 120. For each of the plurality of micro-blog entries 402, a user may, for example, choose to reply and/or repost. In some instances, the UI 400 may receive a plurality of extracted data 302 from the index module 120. For example, the extracted data 302 may appear in a window 404 of the UI 400 that allows the user to make an additional search query based on an opinion, an event, or a quote, thus providing a better browsing experience for users. The additional query may be made, for example, by selecting the underlined text or other control representing a link to the additional query. Alternatively, in response to a selection in the window 404, the plurality of micro-blog entries 402 may be reorganized based on the indexing to surface the micro-blog entries 402 in a different order. In some implementations, UI 400 may be displayed on the web browser 304 of the client device 102.

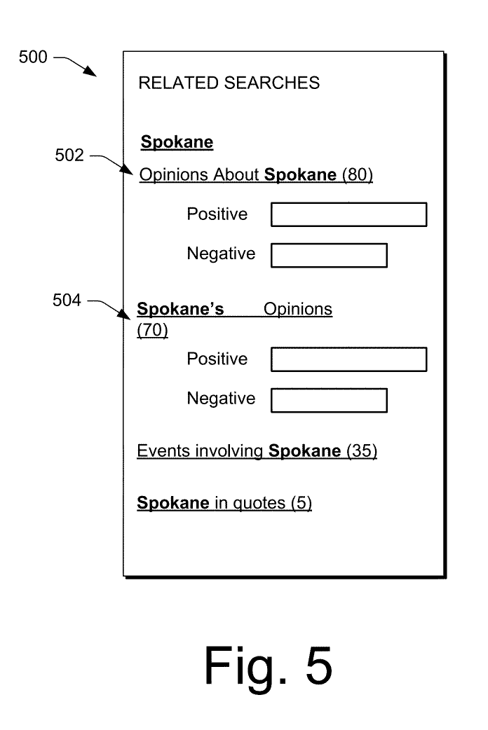

FIG. 5 is a screen rendering of an example UI 500 that illustrates categorizing search results by opinion, event, and quote in greater detail. In some instances, the content of UI 500 may appear in a portion of UI 400. In the example illustrated, UI 500 may include an opinion about the search query 502. For instance, the opinion 502 may be generated by the sentiment analysis module 210. The opinion 502 may be displayed along with a graphical representation of a number of positive and negative sentiments associated with the opinion 502. Additionally, in some instances, a symbol may be associated with the positive and negative representation. For example, a smiling face or thumbs up symbol may be shown adjacent to a positive sentiment, whereas a frowning face or thumbs down may be associated with the negative sentiment.

Also in the illustrated example, UI 500 may include an opinion 504 taken from the perspective of the query. For example, if a search query includes the term ‘Spokane’, opinions generated from the query. In some implementations, UI 500 may be displayed on the web browser 304 of the client device 102.

### Illustrative Target Based Indexing Processes

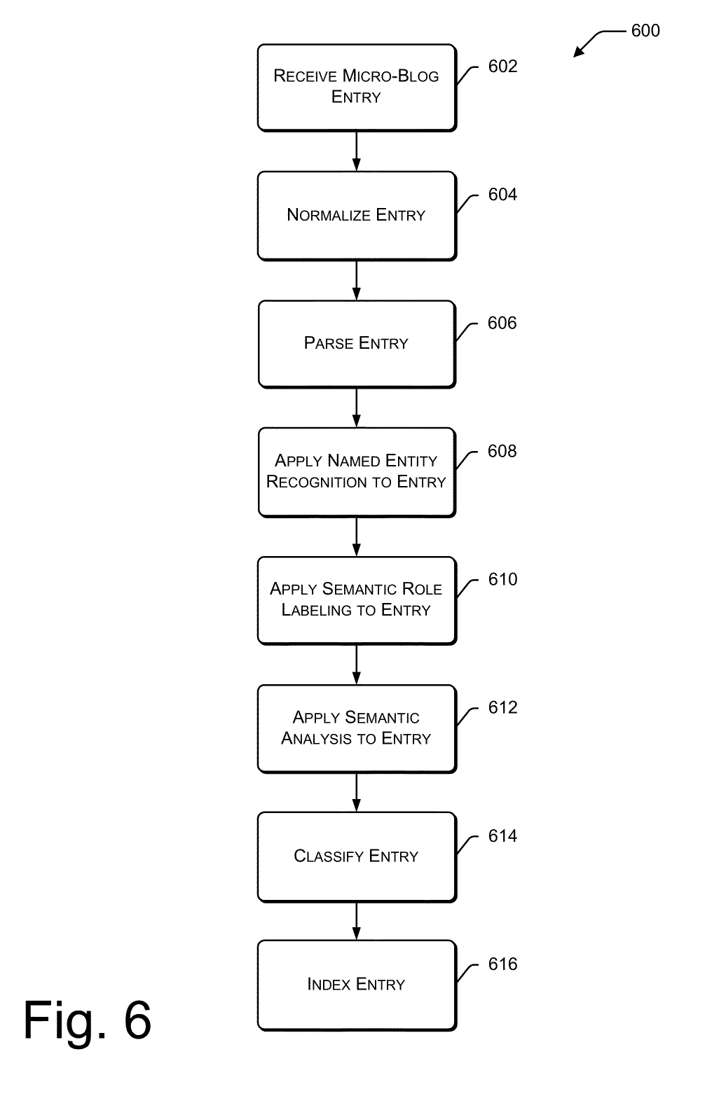

FIG. 6 is a flow diagram showing an illustrative process 600 of extracting and indexing data from micro-blog entries. The process is illustrated as a collection of blocks in a logical flow graph, which represent a sequence of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract. The order in which the operations are described is not intended to be construed as a limitation, and any number of the described blocks can be combined in any order and/or in parallel to implement the process. Moreover, in some embodiments, one or more blocks of the process may be omitted entirely.

The process 600 includes, at operation 602, receiving a micro-blog entry. The micro-blog entry may be received by the request processing module 122 in processing server 110. At 604, the process 600 continues by normalizing the micro-blog entries. For example, the normalization module 202 may correct words in each micro-blog entry that contain missing characters, characters in the wrong order, abbreviations, or character repetition. An operation 606 then parses the micro-blog entry. For instance, the parsing module 204 determines grammar and parts of speech in the entry. An operation 608 includes applying named entity recognition to the micro-blog entry. By way of example, elements of the micro-blog entry are classified into predefined categories by the named entity recognition module 206. At 610, the process 600 continues by applying semantic role labeling to the micro-blog entry. For example, the semantic role labeling module 208 conducts word level labeling by identifying each predicate, and further identifying an argument associated with each predicate.

The process 600 further includes operation 612 which applies semantic analysis to identify and label a sentiment of the micro-blog entry 104. For instance, the sentiment analysis module 210 may label the entry as positive, negative, or neutral. In some embodiments, the sentiment analysis module 210 may label the entry as positive, negative, or neutral based on the entry's relationship to a search query received by the request processing module 122. That is, the sentiment analysis module 210 determines an opinion of the search query and classifies an opinion of the micro-blog entry based on its relation to the opinion in the search query.

An operation 614 then classifies the micro-blog entry. For example, classification module 212 assigns the micro-blog entry to a pre-defined category. The process 600 includes, at operation 616, indexing the micro-blog entry. The indexing may be performed by index module 120.

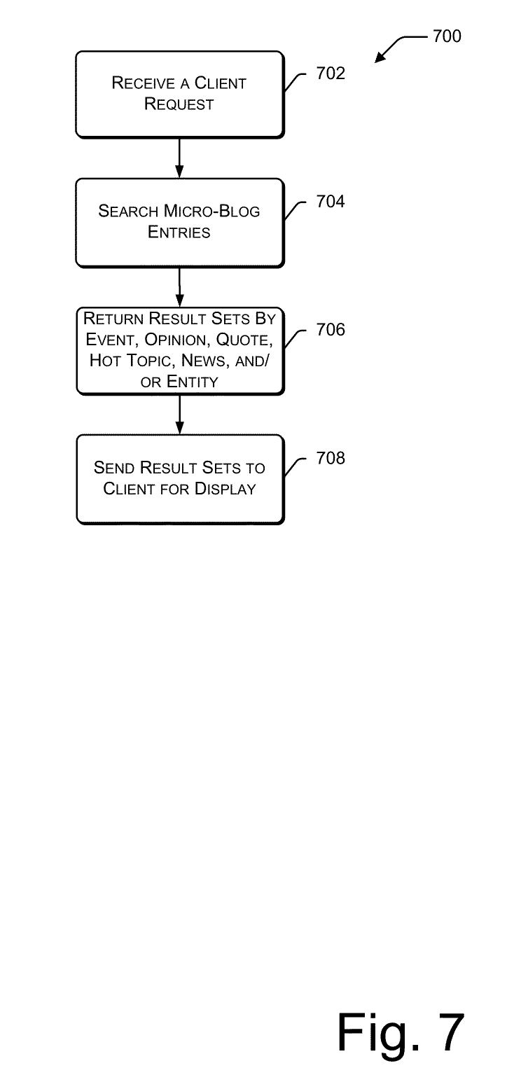

FIG. 7 is a flow diagram showing an illustrative process 700 of searching in conjunction with target based indexing of FIG. 1. Like process 600, process 700 is illustrated as a collection of blocks in a logical flow graph, which represent a sequence of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract. The order in which the operations are described is not intended to be construed as a limitation, and any number of the described blocks can be combined in any order and/or in parallel to implement the process. Moreover, in some embodiments, one or more blocks of the process may be omitted entirely.

Computer storage media includes volatile and non-volatile, removable and non-removable media implemented in any method or technology for storage of information such as computer readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

The process 700 includes, at operation 702, receiving a client request. For example, the request processing module 122 receives a semantic search query from a search box in a web browser. In an alternative implementation, the request processing module 122 receives a structured search query from a search engine. In response to receiving the request, at operation 704, micro-blog entries are searched for content that relates to the request. For example, the index module 120 may look for micro-blog entries 104 with a label or category that relates to the request. Process 700 continues at operation 706 by returning result sets by category. For instance, the index module 120 may return result sets categorized by event, opinion, quote, hot topic, news, or entity. At operation 708, process 700 includes sending result sets to the client device 102 for display.

The data extraction techniques discussed herein are generally discussed in terms of extracting data from a micro-blog entry. However, the data record extraction techniques may be applied to other types of user web content containing user comments associated with web forums and blogs. Accordingly, the data record extraction techniques are not restricted to micro-blog entries.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

1. A system, comprising:
one or more processors; and
memory, communicatively coupled to the one or more processors,
a data extraction module stored in the memory and executable by the processor to:
pre-process a micro-blog entry; and
extract data from the micro-blog entry based at least in part on one or more natural language processing technologies, the one or more natural language processing technologies including named entity recognition (NER) to locate and classify elements in the micro-blog entry into predefined categories, the NER comprising a combination of a k-nearest neighbor (KNN) classifier with a conditional random field (CRF) labeler;
a classification module stored in the memory and executable by the processor to classify the micro-blog entry into pre-defined categories; and
an index module stored in the memory and executable by the processor to:
index the extracted data and the micro-blog entry;
receive a request; and
provide the extracted data and the micro-blog entry based on the request.

2. The system of claim 1, wherein providing the extracted data comprises returning search results or serving categorized micro-blog entries for browsing.

3. The system of claim 1, wherein the pre-processing comprises, for each micro-blog entry:
normalizing the micro-blog entry to identify and correct informal language or misspelled words;
parsing the micro-blog entry based on part-of-speech, chunking, and dependency; and
determining whether to remove the micro-blog entry based on a number of terms in the entry.

4. (canceled)

5. (canceled)

6. The system of claim 1, the one or more natural language processing technologies further including semantic role labeling (SRL) to identify each predicate in the micro-blog entry and an argument associated with each predicate in order to assign a label to the micro-blog entry.

7. The system of claim 6, the SRL caching each assigned label and grouping the micro-blog entry with other similar labeled micro-blog entries.

8. The system of claim 1, the one or more natural language processing technologies further including sentiment analysis (SA) to determine an opinion of the request and classify an opinion of the micro-blog entry based on its relation to the opinion in the request.

9. The system of claim 8, wherein the opinion of the micro-blog entry based on its relation to the opinion in the request is determined by at least one of subjectivity classification, polarity classification, or graph-based optimization.

10. The system of claim 1, the one or more natural language processing technologies further including semantic role labeling (SRL) and sentiment analysis (SA).

11. The system of claim 1, wherein classifying the micro-blog entry into pre-defined categories is determined based at least in part by content of another micro-blog entry or reposting the micro-blog entry.

12. The system of claim 1, wherein the request is a semantic search query or a structured search query.

13. The system of claim 1, wherein the request is received from a search engine or a search box in a web browser.

14. The system of claim 1, wherein an additional data extraction module, an additional classification module, and an additional index module process an additional micro-blog entry in parallel.

15. The system of claim 1, the pre-defined categories including popularity, entity, event, or opinion.

16. A method comprising:
under control of one or more processors:
generating one or more indexes of micro-blog entries based at least in part on one or more natural language processing technologies including named entity recognition (NER), the NER comprising a combination of a k-nearest neighbor (KNN) classifier with a conditional random field (CRF) labeler;
receiving, at a processing server, a search query;
processing the search query against the one or more indexes of micro-blog entries, the indexes being configured to search the micro-blog entries based on a category associated with each micro-blog entry;
surfacing categories of micro-blogs related to the search query; and
making the categories available for access or display.

17. The method of claim 16, wherein the one or more natural language processing technologies further include semantic role labeling (SRL) and sentiment analysis (SA).

18. The method of claim 16, further comprising performing a second search query of an index of micro-blog entries based on the categories displayed.

19. One or more computer readable storage media encoded with instructions that, when executed, direct a computing device to perform operations comprising:
repeatedly downloading micro-blog entries;
filtering the micro-blog entries based on a number of terms in each entry;
applying named entity recognition to locate and classify elements in each entry into pre-defined categories, the named entity recognition comprising a combination of a k-nearest neighbor (KNN) classifier with a conditional random field (CRF) labeler;
applying semantic role labeling to identify each predicate in the micro-blog entries and an argument associated with each predicate in order to assign a label to each entry;
applying sentiment analysis to determine an opinion of a request and classify an opinion of each entry based on its relation to the opinion in the request;
indexing the pre-defined categories, the label, and the opinion associated with each entry;
receiving a search query;
in response to receiving the search query:
returning search results based on the indexing, the search results including both the micro-blog entries and the pre-defined categories, the label, and the opinion associated with each entry; and
making the search results available to a web application.

20. The one or more computer readable storage media of claim 19, wherein the KNN classifier and the CRF labeler are repeatedly retrained based on previous operations, the KNN classifier making a connection between the micro-blog entry and a neighbor in a micro-blog entry graph based on similar content or a cross-reference.
